(19) United States
(12) Patent Application Publication
(10) Pub. No.: US 2026/0086239 A1
(43) Pub. Date: Mar. 26, 2026

(54) LIGHTING MODULE FOR LIDAR APPARATUS

(71) Applicant: HYUNDAI MOBIS CO., LTD., Seoul (KR)

(72) Inventors: Duk Ho DO, Yongin-si (KR); Da Ye KIM, Yongin-si (KR); Dong Joo PARK, Yongin-si (KR)

(73) Assignee: HYUNDAI MOBIS CO., LTD., Seoul (KR)

(21) Appl. No.: 19/061,550

(22) Filed: Feb. 24, 2025

(30) Foreign Application Priority Data
Sep. 26, 2024 (KR) 10-2024-0130872

(51) Int. Cl. G01S 17/931; G01S 7/481

(52) U.S. Cl. CPC G01S 17/931; G01S 7/4815

(57) ABSTRACT

A lighting module for a LiDAR apparatus and a LiDAR apparatus for a vehicle are provided. The lighting module includes a VCSEL array provided with light-emitting sections to emit light in a direction parallel to a first axis, a light shifter disposed to face the VCSEL array, wherein the light shifter reduces a gap between the light emitted from adjacent ones of the light-emitting sections, and a collimator disposed to face the light shifter.

### CROSS-REFERENCE TO RELATED APPLICATION(S)

This application claims priority to and the benefit under 35 USC § 119 of Korean Patent Application No. 10-2024-0130872, filed on Sep. 26, 2024, in the Korean Intellectual Property Office, which is hereby incorporated by reference for all purposes.

### BACKGROUND

### 1. Field

Exemplary embodiments of the present disclosure relate to a lighting module for a LiDAR apparatus, and more particularly, to a lighting module for a LiDAR apparatus, which may enhance lighting uniformity.

### 2. Description of the Related Art

Fixed LiDAR(Light Detection and Ranging) sensors used for position recognition of mobility systems such as vehicles and robots are typically composed of a lighting part and a receiving part without a driving part for beam scanning. The lighting part primarily uses an array-type vertical cavity surface emitting laser (VCSEL) as a light source, and for light reflecting off an object, time taken for the light to return is measured through the receiving part, which is composed of other optical parts and a single-photon avalanche diode (SPAD) sensor. Unlike rotating LiDARs using a rotating mirror or the like, fixed LiDARs have no mechanical driving part, and thus is resistant to vibration. However, due to their relatively weak sensing sensitivity, fixed LiDARs are utilized for short-range sensing.

Conventional fixed LiDAR sensors typically dispose multiple VCSELs in separate zones in order to increase a field of view or sensing sensitivity. As a result, gaps inevitably occur between each zone. Accordingly, an area of non-uniformity in lighting occurs due to the gaps between each zone when an array of multiple VCSELs is used.

### SUMMARY

An objective of the present disclosure is to provide a lighting module for a LiDAR apparatus, which may enhance lighting uniformity.

In a general aspect of the disclosure, a lighting module for a LiDAR apparatus includes a VCSEL array provided with light-emitting sections configured to emit light in a direction parallel to a first axis, a light shifter disposed to face the VCSEL array, and configured to reduce a gap between the light emitted from adjacent ones of the light-emitting sections, and a collimator disposed to face the light shifter.

The light shifter may include optical elements disposed to face each of the light-emitting sections.

Each of the optical elements may include a first surface disposed to face the light-emitting sections, and a second surface disposed to face the collimator and disposed to form an inclination angle with respect to the first surface.

The optical elements may include a first optical element spaced apart by a first set distance from the first axis, and a second optical element spaced apart by a second set distance, the second set distance being greater than the first set distance, from the first axis, wherein the inclination angle of the second surface of the second optical element may be greater than the inclination angle of the second surface of the first optical element.

The optical elements may include diffractive optical elements configured to diffract the light emitted from the light-emitting sections.

Each of the optical elements includes grating patterns arranged at set spacing along a direction intersecting the first axis.

The optical elements may include a first optical element spaced apart a first set distance from the first axis, and a second optical element spaced apart a second set distance, the second set distance being greater than the first set distance, from the first axis, wherein set spacing of the second optical element may be smaller than set spacing of the first optical element.

The optical elements may be a birefringent material configured to cause birefringence in the light emitted from the light-emitting sections.

Each of the optical elements may include a first surface disposed to face the light-emitting sections, and a second surface disposed to face the collimator and disposed parallel to the first surface.

Optical axes of the optical elements may be disposed symmetrically with respect to the first axis.

The optical elements may include a first optical element spaced apart a first set distance from the first axis, and a second optical element spaced apart a second set distance, greater than the first set distance, from the first axis, wherein a thickness of the second optical element may be greater than a thickness of the first optical element.

The lighting module may further include a wave plate disposed between the optical elements and the light emitting sections.

The wave plate may be a quarter wave plate.

Each of the light-emitting sections may include at least one light-emitting element, wherein each of the optical elements may include at least one micro lens disposed to face the light-emitting element.

A central axis of the light-emitting element and a central axis of the micro lens may be spaced apart by an offset distance from each other along a direction intersecting the first axis.

The optical elements may include a first optical element spaced apart a first set distance from the first axis, and a second optical element spaced apart a second set distance, greater than the first set distance, from the first axis, wherein an offset distance of the second optical element may be greater than an offset distance of the first optical element.

In another general aspect of the disclosure, a LiDAR apparatus for a vehicle, includes: a lighting module disposed on the LiDAR apparatus and including a VCSEL array including a plurality of light-emitting sections that emit light in a direction parallel to a first axis, a light shifter comprises a plurality of optical elements disposed to face each of the light-emitting sections, and a collimator disposed to face the light shifter, wherein the light shifter converges paths of light emitted from the plurality of light-emitting sections toward the first axis, and reduces a gap between the light emitted from adjacent ones of the light-emitting sections.

The light shifter may prevent occurrence of an area of non-uniformity in the lighting output from the lighting module.

Each of the optical elements may include a first surface disposed to face the light-emitting sections, and a second surface disposed to face the collimator and disposed to form an inclination angle with respect to the first surface.

The optical elements may include refractive optical elements having one or more unique refractive indexes that refract light incident from the light-emitting sections.

According to the present disclosure, the sensing sensitivity of the LiDAR apparatus may be further enhanced by eliminating an area of non-uniformity, in the output lighting, caused by the physical gap between the adjacent light emitting sections.

According to the present disclosure, a plurality of light-emitting sections may be easily disposed, thereby improving a field of view of the lighting module and increasing a detection range.

### BRIEF DESCRIPTION OF THE DRAWINGS

FIG. 1 is a view schematically showing a configuration of a lighting module for a LiDAR apparatus according to a first embodiment of the present disclosure.

FIG. 2 is a plan view schematically showing a configuration of a VCSEL array according to the first embodiment of the present disclosure.

FIG. 3 is a plan view schematically showing a configuration of a shifting unit according to the first embodiment of the present disclosure.

FIG. 4 is a side view schematically showing a configuration of the shifting unit according to the first embodiment of the present disclosure.

FIG. 5 is an enlarged view schematically showing a configuration of any one pair of optical elements among a plurality of optical elements according to the first embodiment of the present disclosure.

FIG. 6 and FIG. 7 are views showing a change in an optical path by the lighting module for a LiDAR apparatus according to the first embodiment of the present disclosure.

FIG. 8 is a plan view schematically showing a configuration of a shifting unit according to a second embodiment of the present disclosure.

FIG. 9 is a side view schematically showing a configuration of the shifting unit according to the second embodiment of the present disclosure.

FIG. 10 is an enlarged view schematically showing a configuration of any one pair of optical elements among a plurality of optical elements according to the second embodiment of the present disclosure.

FIG. 11 is a plan view schematically showing a configuration of a shifting unit according to a third embodiment of the present disclosure.

FIG. 12 is a plan view schematically showing a configuration of a shifting unit to a fourth embodiment of the present disclosure.

FIG. 13 is an enlarged view schematically showing a configuration of any one pair of optical elements among a plurality of optical elements according to the fourth embodiment of the present disclosure.

FIG. 14 is a plan view schematically showing a configuration of a shifting unit according to a fifth embodiment of the present disclosure.

FIG. 15 is a side view schematically showing a configuration of the shifting unit according to the fifth embodiment of the present disclosure.

FIG. 16 is an enlarged view schematically showing a configuration of any one pair of optical elements among a plurality of optical elements according to the fifth embodiment of the present disclosure.

### DETAILED DESCRIPTION

Hereinafter, the present disclosure will be described below with reference to the accompanying drawings through various exemplary embodiments.

It should be considered that the thickness of each line or the size of each component in the drawings may be exaggeratedly illustrated for clarity and convenience of description. In addition, the terms as used herein are defined in consideration of functions of the present disclosure, and these terms may change depending on an occupant or operator's intention or practice. Therefore, definitions of these terms will have to be made based on the content herein.

In addition, in the present specification, when one element is described as being “connected (or coupled)” to another element, it may be “directly connected (or coupled)” to another element, or may be “indirectly connected (or coupled)” to another element with other elements interposed therebetween. In the present specification, when one element is described to “comprise (or include)” one element, this is not intended to preclude any other elements, but rather may further “comprise (or include)” other elements, unless specifically stated otherwise.

In addition, the same reference numerals may refer to the same elements herein. Even if the same or similar reference numerals are not mentioned or described in a particular drawing, such reference numerals may be described on the basis of other drawings. Similarly, even if one element is not identified by a reference numeral in a particular drawing, the element may be described on the basis of other drawings. In addition, the number, shape, size, and relative differences in size of constituent elements, and the like illustrated in the drawings of the present disclosure are set for ease of understanding. Embodiments are not limited thereto, and may be implemented in various forms.

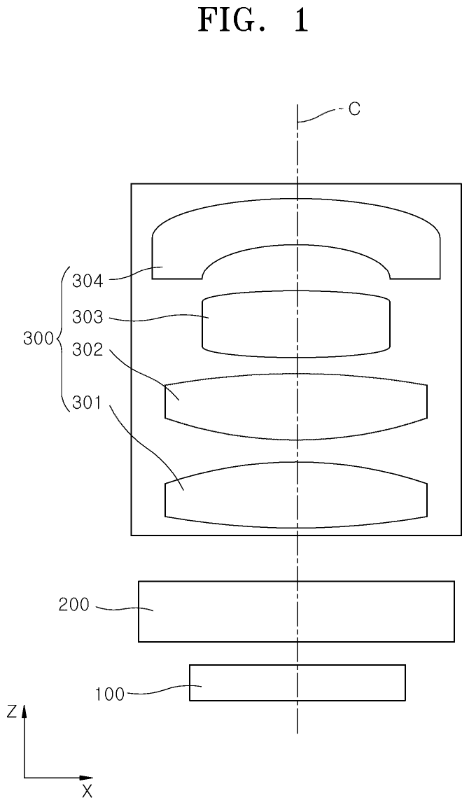

FIG. 1 is a view schematically showing a configuration of a lighting module for a LiDAR apparatus according to a first embodiment of the present disclosure.

Referring to FIG. 1, the lighting module for a LiDAR apparatus according to the present embodiment includes a VCSEL array 100, a shifting unit 200 (e.g., a light shifter), and a collimation unit 300 (e.g., a collimator).

The VCSEL array 100 may emit light in a direction parallel to a first axis C. The light emitted from the VCSEL array 100 may be laser light. The first axis C is a central axis of light emitted from the VCSEL array 100, and may be disposed parallel to the z-axis in FIG. 1. The first axis C may vertically penetrate a central area of the VCSEL array 100.

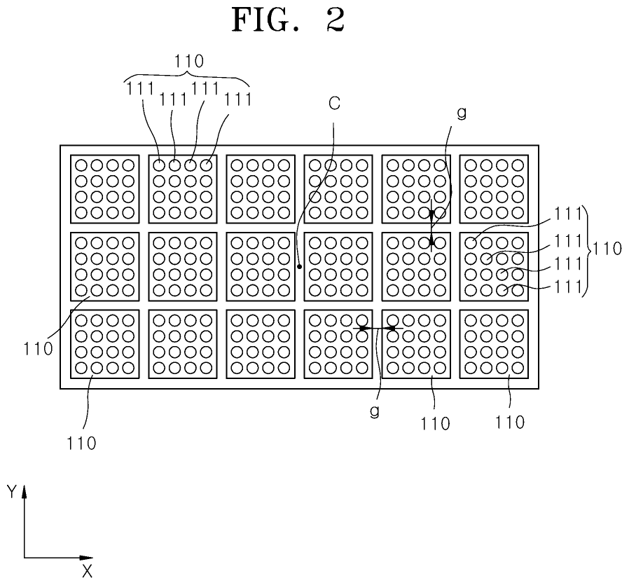

FIG. 2 is a plan view schematically showing a configuration of a VCSEL array according to the first embodiment of the present disclosure.

The VCSEL array 100 according to the present embodiment may include a plurality of light-emitting sections 110.

The plurality of light-emitting sections 110 may be disposed to be spaced apart from each other on a plane perpendicular to the first axis C, more specifically, on an XY plane in FIGS. 1 and 2. The plurality of light-emitting sections 110 may be disposed in a grid pattern on the plane perpendicular to the first axis C. For example, the plurality of light-emitting sections 110 may be disposed in at least two rows along the x-axis and the y-axis. The plurality of light-emitting sections 110 may be disposed symmetrically with respect to the first axis C. For example, the number of the plurality of light-emitting sections 110 arranged in one direction along the X-axis with respect to the first axis C may be the same as the number of the plurality of light-emitting sections 110 arranged in the opposite direction along the X-axis. In addition, the number of the plurality of light-emitting sections 110 arranged in one direction along the Y-axis with respect to the first axis C may be the same as the number of the plurality of light-emitting sections 110 arranged in the opposite direction along the Y-axis.

An adjacent pair of the light-emitting sections 110 may be disposed to be spaced apart a set gap g from each other along a direction perpendicular to the first axis C, more specifically, along the x-axis or the y-axis.

Each of the light-emitting sections 110 may individually emit light in a direction parallel to the first axis C. The light emitted from the adjacent pair of the light-emitting sections 110 may be spaced apart the set gap g from each other along the direction perpendicular to the first axis C.

The light-emitting sections 110 according to the present embodiment may include a light-emitting element 111.

The light-emitting element 111 will be described below using an example in which a plurality of the light-emitting elements 111 are formed. However, the light-emitting element 111 is not limited thereto, and may also be formed singly.

The light-emitting element 111 may function as a unit structure that generates light emitted from the light-emitting sections 110. The number of the plurality of the light-emitting elements 111 provided in each of the light-emitting sections 110 may be the same.

The light-emitting element 111 according to the present embodiment may be exemplified by various types of light sources capable of generating laser light, such as a semiconductor laser. The laser light generated from the light-emitting element 111 may have a wavelength of 940 nm. The light-emitting element 111 may be disposed to have a central axis C1 parallel to the first axis C. The light-emitting element 111 may emit light in a direction parallel to the central axis C1 and toward the shifting unit 200, which will be described later.

The plurality of the light-emitting elements 111 may be disposed within an area where the light-emitting sections 110 are positioned. In each of the light-emitting sections 110, the plurality of the light-emitting elements 111 may be disposed to form a grid pattern on the plane perpendicular to the first axis C. For example, in each of the light-emitting sections 110, the plurality of the light-emitting elements 111 may be disposed in at least two rows along the x-axis and the y-axis. A gap between adjacent light-emitting elements 111 may be smaller than the set gap g between the adjacent light-emitting sections 110.

The shifting unit 200 may be disposed to face the VCSEL array 100 in the direction parallel to the first axis C. The shifting unit 200 may reduce a gap between the light emitted from the adjacent light-emitting sections 110. Accordingly, the shifting unit 200 may prevent an occurrence of an area of non-uniformity, in the lighting output from the lighting module, caused by the physical gap between the adjacent light-emitting sections 110, and further enhance sensing sensitivity of the LiDAR apparatus.

The shifting unit 200 according to the present embodiment may converge paths of light emitted from the plurality of light-emitting sections 110 toward the first axis C. That is, the paths of light emitted from each of the light-emitting sections 110 in the direction parallel to the first axis C may be switched to a direction toward the first axis C when the light passes through the shifting unit 200.

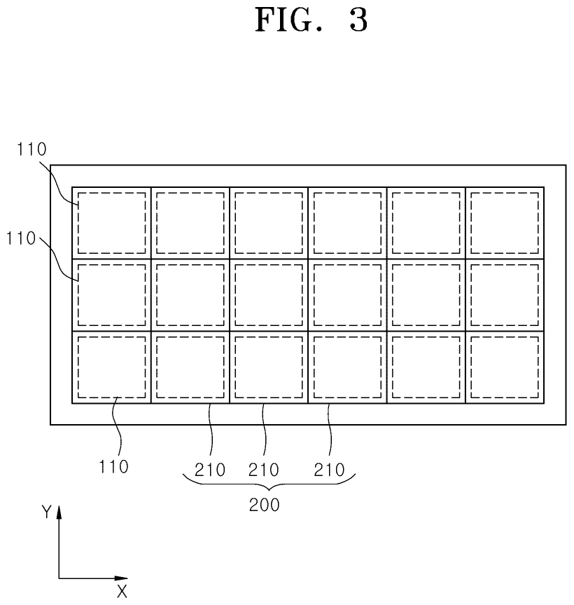

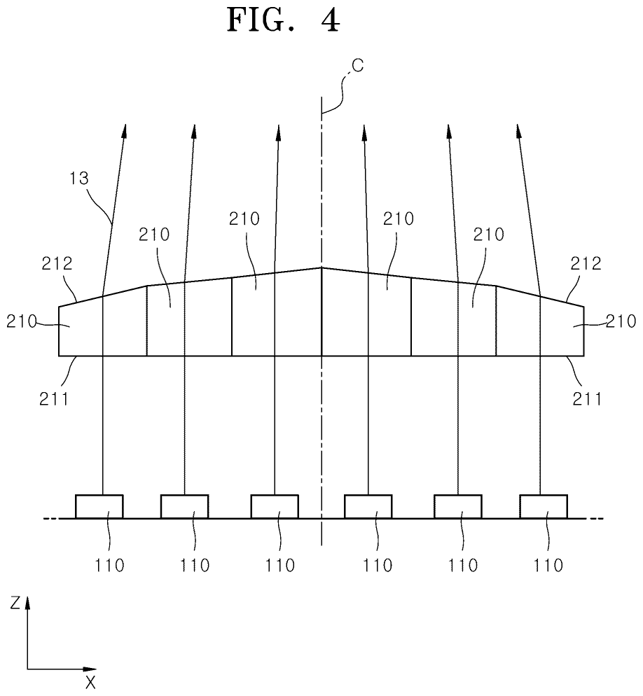

FIG. 3 is a plan view schematically showing a configuration of a shifting unit 200 according to the first embodiment of the present disclosure. FIG. 4 is a side view schematically showing a configuration of the shifting unit 200 according to the first embodiment of the present disclosure.

Referring to FIGS. 3 and 4, the shifting unit 200 according to the present embodiment may include a plurality of optical elements 210.

Each of the optical elements 210 may function as a unit structure that constitutes a portion of an area of the shifting unit 200. Each of the optical elements 210 may be disposed to face different light-emitting sections 110 along the direction parallel to the first axis C.

The optical elements 210 according to the present embodiment may be refractive optical elements having a unique refractive index to refract light incident from the light-emitting sections 110. Materials such as glass or plastic may be used for the optical elements 210.

The optical elements 210 may include a first surface 211 and a second surface 212 that are spaced apart from each other along the first axis C.

The first surface 211 may receive light emitted from the light-emitting sections 110.

The first surface 211 according to the present embodiment may be exemplified by a lower surface of the optical elements 210 disposed to face the light-emitting sections 110. The first surface 211 may be disposed perpendicular to the first axis C. Light emitted from the plurality of the light-emitting elements 111 provided in any one of the light-emitting sections 110 may be incident on the first surface 211 in the direction parallel to the first axis C.

The second surface 212 may refract the light incident on the first surface 211.

The second surface 212 according to the present embodiment may be exemplified by an upper surface of the optical elements 210 disposed to face the collimation unit 300. The second surface 212 may be disposed to form an inclination angle relative to the first surface 211. The second surface 212 may be disposed to be inclined upward toward the first axis C. For example, the optical elements 210 according to the present embodiment may have a shape where a thickness thereof increases toward the first axis C. Accordingly, the optical elements 210 may refract the path of light 13, emitted from the second surface 212, in the direction toward the first axis C.

The second surfaces 212 of the plurality of optical elements 210 may be disposed symmetrically with respect to the first axis C. For example, each of the optical elements 210 may be disposed such that an upper end portion of the normal to the second surface 212 converges toward the first axis C. Accordingly, the plurality of optical elements 210 may converge the light emitted from each of the light-emitting sections 110 toward the first axis C.

Each of the optical elements 210 may individually adjust the path of light emitted from different light-emitting sections 110. For example, each of the optical elements 210 may refract light, emitted from different light-emitting sections 110, at different angles.

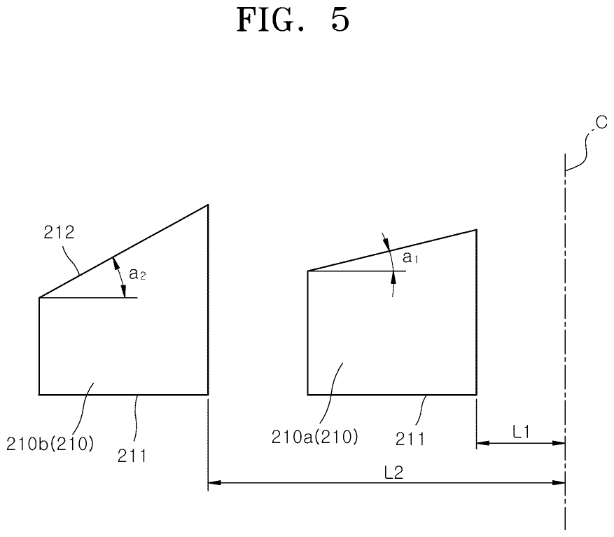

FIG. 5 is an enlarged view schematically showing a configuration of any one pair of optical elements among a plurality of optical elements according to the first embodiment of the present disclosure.

Referring to FIGS. 1 to 5, the optical elements 210 according to the present embodiment may include a first optical element 210a and a second optical element 210b.

The first optical element 210a and the second optical element 210b may be any one pair of the plurality of optical elements 210, spaced apart different distances from the first axis C, among the plurality of optical elements 210.

For example, the first optical element 210a may be spaced apart a first set distance L1 from the first axis C along the direction perpendicular to the first axis C. The second optical element 210b may be spaced apart a second set distance L2, which is greater than the first set distance L1, from the first axis C along the direction perpendicular to the first axis C. FIG. 5 illustrates an example in which the first optical element 210a and the second optical element 210b are both spaced apart from the first axis C along the X-axis. However, the present disclosure is not limited thereto, and the first optical element 210a and the second optical element 210b may both be spaced apart along the Y-axis, or may be spaced apart along the X-axis and the Y-axis, respectively, or may be spaced apart in different directions within a range of directions perpendicular to the first axis C other than the X-axis and the Y-axis.

An inclination angle a2 of the second optical element 210b may be greater than an inclination angle a1 of the first optical element 210a. Accordingly, the shifting unit 200 according to the present embodiment may further enhance lighting uniformity by forming a refraction angle of light emitted from the light-emitting sections 110 positioned relatively far from the first axis C to be greater than a refraction angle of light emitted from the light-emitting sections 110 positioned relatively close to the first axis C. The inclination angle a2 of the second optical element 210b and the inclination angle a1 of the first optical element 210a may have different values within a range of 0.2° to 31.4°. In this case, the angles of light refracted from the first optical element 210a and the second optical element 210b may have different values within a range of 0.1° to 20°.

The collimation unit 300 may be disposed to face the shifting unit 200. The collimation unit 300 may function as an element that aligns a plurality of light paths passing through the shifting unit 200 in parallel.

The collimation unit 300 according to the present embodiment may include a plurality of collimation lenses 301, 302, 303, and 304 arranged sequentially along the first axis C. Each of the collimation lenses 301, 302, 303, and 304 may have at least one of the following forms: a convex lens, a concave lens, a spherical lens, an aspherical lens, and a Fresnel lens. FIG. 1 illustrates an example in which a plurality of the collimation units 300 include the four collimation lenses 301, 302, 303, and 304. However, the number of collimation lenses is not limited thereto, and may vary with a design change.

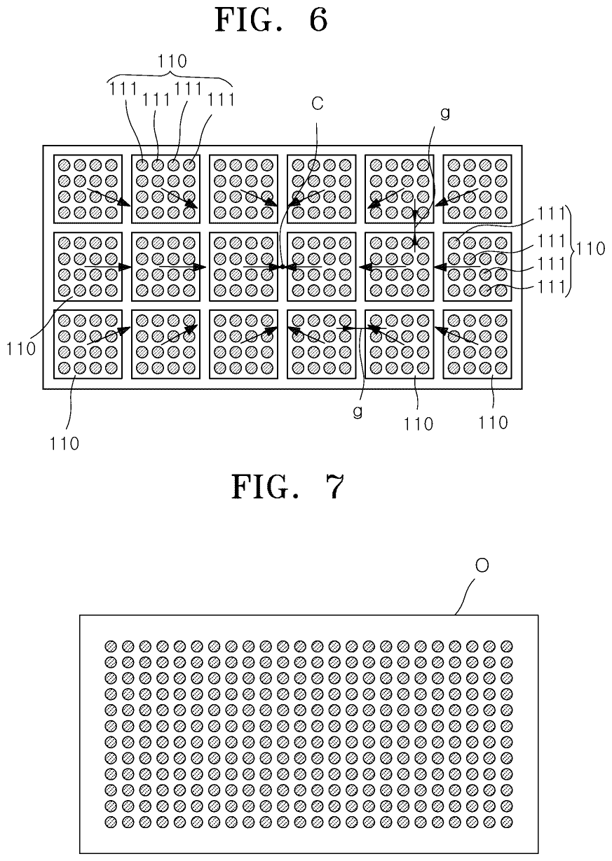

FIG. 6 and FIG. 7 are views showing a change in an optical path by the lighting module for a LiDAR apparatus according to the first embodiment of the present disclosure.

Referring to FIGS. 6 and 7, since the adjacent pair of the light-emitting sections 110 are spaced apart the set gap g from each other in the direction perpendicular to the first axis C, a discontinuous section corresponding to the set gap g appears in a light pattern emitted from an entirety of the VCSEL array 100.

The path of the light emitted from each of the light-emitting sections 110 may pass through the shifting unit 200 and be shifted toward the first axis C, and the gap between the light emitted from the adjacent light-emitting sections 110 may be reduced.

The light emitted from the light-emitting sections 110 may then pass through the collimation unit 300 and be aligned parallel to the first axis C.

Accordingly, the light pattern finally emitted to a detection target O may be formed such that the discontinuous section corresponding to the initial set gap g is removed and a continuous pattern is formed over an entirety of the detection area.

The lighting module for a LiDAR apparatus according to a second embodiment of the present disclosure will be described below.

The lighting module for a LiDAR apparatus according to the present embodiment may be configured to differ from the lighting module for a LiDAR apparatus according to the first embodiment of the present disclosure only in a detailed configuration of the shifting unit 200.

Accordingly, in describing the lighting module for a LiDAR apparatus according to the present embodiment, only the detailed configuration of the shifting unit 200 that is different from the lighting module for a LiDAR apparatus according to the first embodiment of the present disclosure will be described.

For the rest of the configuration of the present disclosure, the same description of the lighting module for a LiDAR apparatus according to the first embodiment of the present disclosure may be applied.

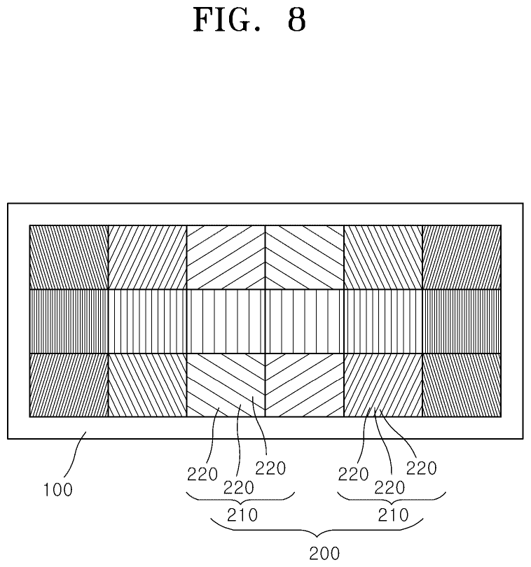

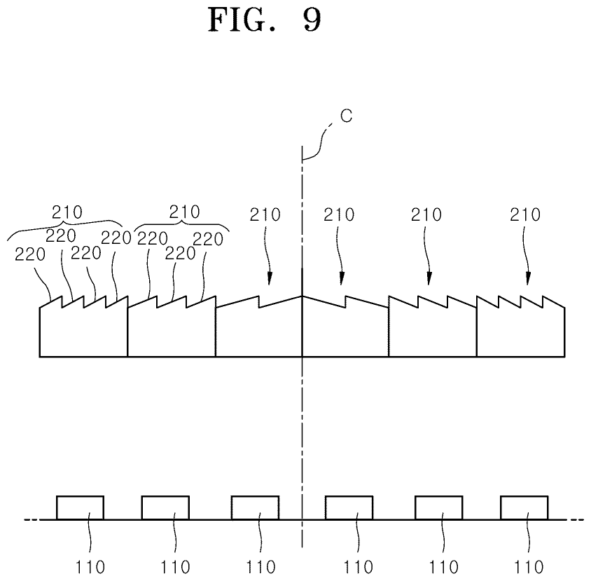

FIG. 8 is a plan view schematically showing a configuration of a shifting unit according to a second embodiment of the present disclosure. FIG. 9 is a side view schematically showing a configuration of the shifting unit according to the second embodiment of the present disclosure.

Referring to FIGS. 8 and 9, the shifting unit 200 according to the present embodiment may use a diffraction effect of light to adjust the path of light emitted from the light-emitting sections 110 and reduce a gap between light emitted from adjacent light-emitting sections 110.

The optical elements 210 according to the present embodiment may be diffractive optical elements that diffract the light emitted from the light-emitting sections 210.

The optical elements 210 may take a form of a diffraction grating that includes a plurality of grating patterns 220 arranged at set spacing along a direction intersecting the first axis C, more specifically, along the direction perpendicular to the first axis C.

The grating patterns 220 according to the present embodiment may protrude from the upper surface of the optical elements 210 facing the collimation unit 300 in the direction parallel to the first axis C. A cross-sectional shape of the grating patterns 220 may vary with a design change, such as a rectangle, trapezoid, semicircle, arc, and semi-ellipse shapes, in addition to a triangle or blaze shape illustrated in FIG. 9. The set spacing of the grating patterns 220 may mean a distance between identical points of adjacent grating patterns 220.

The grating patterns 220 of the plurality of optical elements 210 may be arranged symmetrically with respect to the first axis C. The grating patterns 220 of each of the optical elements 210 may be arranged along an imaginary straight line connecting the first axis C and a central axis of the optical elements 210. Here, the central axis of the optical elements 210 may mean a straight line penetrating a center of gravity of the optical elements 210 in the direction parallel to the first axis C. For example, the grating patterns 220 of the optical elements 210 arranged in a direction parallel to the X-axis from the first axis C may be arranged along the X-axis.

Light incident from the light-emitting sections 110 onto the optical elements 210 may be diffracted while passing through the grating patterns 220. That is, the light that has passed through the grating patterns 220 may be dispersed into multiple lays of diffracted light having a constant diffraction angle, and may proceed toward the collimation unit 300. A portion of the diffracted light proceeding toward the collimation unit 300 may fill a non-light-emitting area formed between the adjacent light-emitting sections 110, thereby reducing the gap between the light emitted from the adjacent light-emitting sections 110.

For example, a portion of the diffracted light that has passed through the grating patterns 220 of the plurality of optical elements 210 may proceed in the direction toward the first axis C.

Since the grating patterns 220 of the plurality of optical elements 210 are arranged symmetrically with respect to the first axis C, a portion of the light that has passed through the shifting unit 200 may converge toward the first axis C.

Each of the optical elements 210 may diffract light, emitted from different light-emitting sections 110, at different angles.

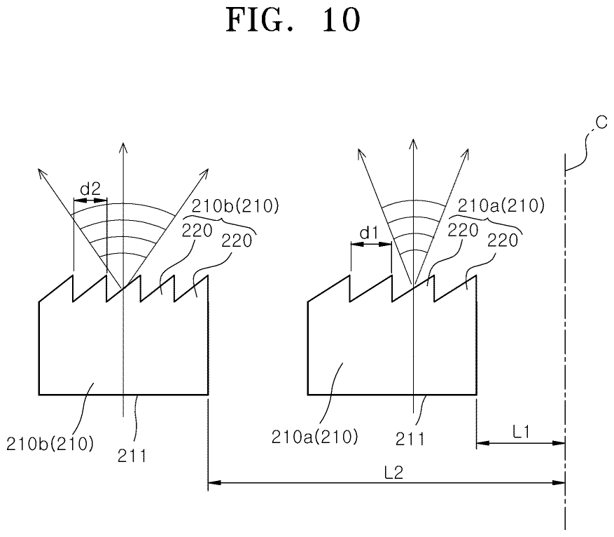

FIG. 10 is an enlarged view schematically showing a configuration of any one pair of optical elements among a plurality of optical elements according to the second embodiment of the present disclosure.

Referring to FIGS. 8 to 10, set spacing d2 of the grating patterns 220 of the second optical element 210b according to the present embodiment may be smaller than set spacing d1 of the grating patterns 220 of the first optical element 210a. The set spacing d2 of the grating patterns 220 of the second optical element 210b being smaller than the set spacing d1 of the grating patterns 220 of the first optical element 210a may mean that the number of the grating patterns 220 per unit area of the second optical element 210b is greater than the number of the grating patterns 220 per unit area of the first optical element 210a. Accordingly, the shifting unit 200 according to the present embodiment may further enhance lighting uniformity by forming a diffraction angle of light emitted from the light-emitting sections 110 positioned relatively far from the first axis C to be greater than a diffraction angle of light emitted from the light-emitting sections 110 positioned relatively close to the first axis C.

The set spacing d2 of the grating patterns 220 of the second optical element 210b and the set spacing d1 of the grating patterns 220 of the first optical element 210a may have different values within a range of 1 μm to 600 μm, more specifically, 2.748 μm to 538.6 μm. In addition, the angles of light refracted from the first optical element 210a and the second optical element 210b may have different values within a range of 0.1° to 20°.

The optical elements 210 have been described above using the example in which the optical elements 210 are diffraction gratings having the plurality of grating patterns 220. However, the present disclosure is not limited thereto, and various types of diffracted optical elements capable of producing diffraction of light may be used, such as a volume holographic grating (VHG) or holographic optical element (HOE) having periodic refractive index changes within a medium.

The lighting module for a LiDAR apparatus according to a third embodiment of the present disclosure will be described below.

The lighting module for a LiDAR apparatus according to the present embodiment may be configured to differ from the lighting module for a LiDAR apparatus according to the first embodiment of the present disclosure only in a detailed configuration of the shifting unit 200.

Accordingly, in describing the lighting module for a LiDAR apparatus according to the present embodiment, only the detailed configuration of the shifting unit 200 that is different from the lighting module for a LiDAR apparatus according to the first embodiment of the present disclosure will be described.

For the rest of the configuration of the present disclosure, the same description of the lighting module for a LiDAR apparatus according to the first embodiment of the present disclosure may be applied.

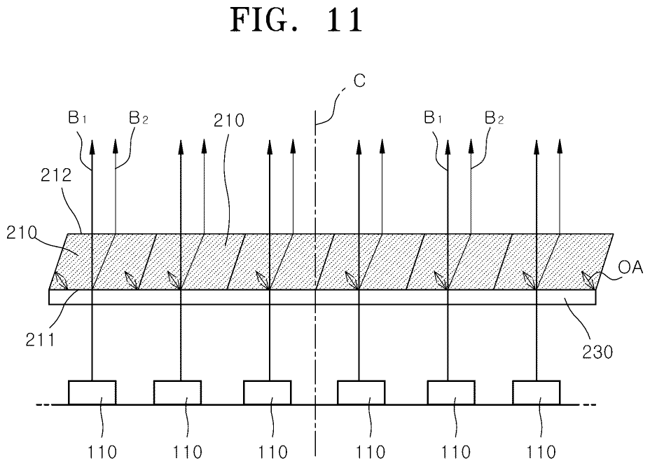

FIG. 11 is a plan view schematically showing a configuration of a shifting unit according to the third embodiment of the present disclosure.

The shifting unit 200 according to the present embodiment may use a birefringence effect of light to adjust the path of light emitted from the light-emitting sections 110 and reduce a gap between light emitted from adjacent light-emitting sections 110.

The optical elements 210 according to the present embodiment may be a birefringent material that causes birefringence in the light emitted from the light-emitting sections 110. Birefringent materials are materials that have different refractive indices depending on the polarization direction, and may include anisotropic materials such as alpha-barium borate (alpha-BBO), calcite, quartz, and YVO4.

The first surface 211 and the second surface 212 of the optical elements 210 according to the present embodiment may be disposed perpendicular to the first axis C and parallel to each other.

Optical axes OA of the optical elements 210 according to the present embodiment may be disposed to be inclined, at a predetermined angle, with respect to the light incident from the light-emitting sections 110 onto the optical elements 210. Accordingly, the optical elements 210 may cause birefringence in the light incident from the light-emitting sections 110. In the present embodiment, the optical axes OA of the plurality of optical elements 210 may be disposed parallel to each other.

The shifting unit 200 according to the present embodiment may further include a wave plate 230.

The wave plate 230 may be disposed between the optical elements 210 and the light-emitting sections 110. The wave plate 230 may adjust a polarization direction of the light emitted from the optical elements 210.

The wave plate 230 according to the present embodiment may be exemplified by a quarter wave plate that uses the birefringence effect to create a 90° phase difference between two polarization components.

The light generated from the light-emitting element 111 according to the present embodiment may be linearly polarized laser light.

A polarization direction of the light incident from the light-emitting sections 110 onto the wave plate 230 may be adjusted by the wave plate 230 to have polarization components that are orthogonal to each other.

Light that has passed through the wave plate 230 may be incident on the optical elements 210 perpendicular to the first surface 211.

The light incident on the optical elements 210 may be split into an ordinary ray B1 and an extraordinary ray B2 due to the birefringent properties of the optical elements 210.

Accordingly, a portion of the light emitted from the light-emitting sections 110, i.e., the extraordinary ray B2, may fill the non-light-emitting area formed between the adjacent light-emitting sections 110, thereby reducing the gap between the light emitted from the adjacent light-emitting sections 110.

In addition, in the present embodiment, if the light generated from the light-emitting element 111 is circularly polarized or elliptically polarized light, the wave plate 230 may be omitted.

The lighting module for a LiDAR apparatus according to a fourth embodiment of the present disclosure will be described below.

The lighting module for a LiDAR apparatus according to the present embodiment may be configured to differ from the lighting module for a LiDAR apparatus according to the third embodiment of the present disclosure only in a detailed configuration of the optical elements 210.

Accordingly, in describing the lighting module for a LiDAR apparatus according to the present embodiment, only the detailed configuration of the optical elements 210 that is different from the lighting module for a LiDAR apparatus according to the third embodiment of the present disclosure will be described.

For the rest of the configuration of the present disclosure, the same description of the lighting module for a LiDAR apparatus according to the third embodiment of the present disclosure may be applied.

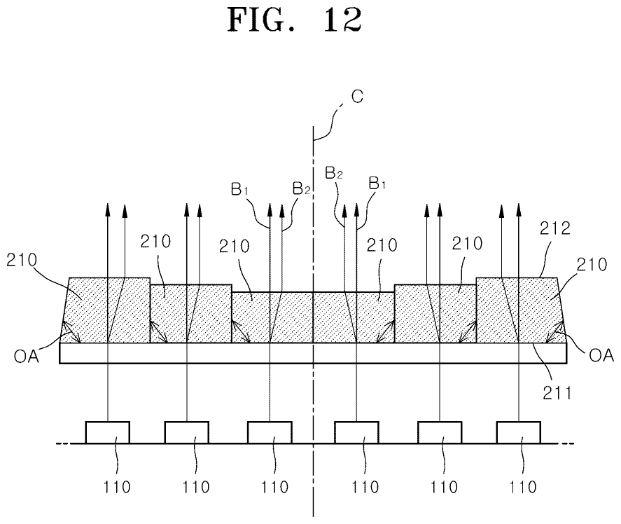

FIG. 12 is a plan view schematically showing a configuration of a shifting unit to the fourth embodiment of the present disclosure.

FIG. 12 illustrates an example in which the shifting unit 200 according to the present embodiment includes the wave plate 230. However, the present embodiment is not limited thereto, and the shifting unit 200 may be configured not to include the wave plate 230.

Referring to FIG. 12, the optical axes OA of the plurality of optical elements 210 according to the present embodiment may be disposed symmetrically with respect to the first axis C. That is, the optical axes OA of the plurality of optical elements 210 may be disposed such that the extraordinary ray B2 passing through the optical elements 210 is refracted toward the first axis C. Accordingly, the plurality of optical elements 210 may further enhance lighting uniformity by converging the extraordinary ray B2, which is split from the light emitted from each of the optical elements 210, toward the first axis C.

Each of the optical elements 210 may refract the extraordinary ray B2, which is split from the light emitted from different light-emitting sections 110, at different angles.

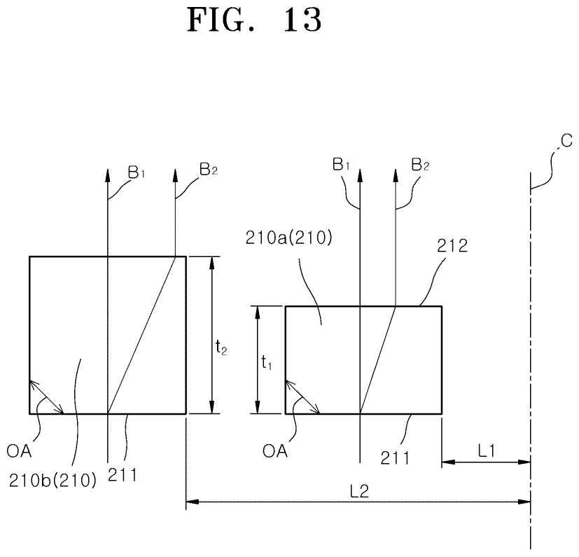

FIG. 13 is an enlarged view schematically showing a configuration of any one pair of optical elements among a plurality of optical elements according to the fourth embodiment of the present disclosure.

Referring to FIGS. 12 and 13, a thickness t2 of the second optical element 210b according to the present embodiment may be greater than a thickness t1 of the first optical element 210a. The thickness t1 of the first optical element 210a according to the present embodiment may mean a distance between the first surface 211 and the second surface 212 of the first optical element 210a, and the thickness t2 of the second optical element 210b may mean a distance between the first surface 211 and the second surface 212 of the second optical element 210b.

Accordingly, the shifting unit 200 according to the present embodiment may further enhance lighting uniformity by forming a refraction angle of the extraordinary ray B2 split from the light emitted from the light-emitting sections 110 positioned relatively far from the first axis C to be greater than a refraction angle of the extraordinary ray B2 split from the light emitted from the light-emitting sections 110 positioned relatively close to the first axis C.

The thickness t2 of the second optical element 210b and the thickness t1 of the first optical element 210a may have different values within a range of 184.1 μm to 9.21 mm.

The lighting module for a LiDAR apparatus according to a fifth embodiment of the present disclosure will be described below.

The lighting module for a LiDAR apparatus according to the present embodiment may be configured to differ from the lighting module for a LiDAR apparatus according to the first embodiment of the present disclosure only in a detailed configuration of the optical elements 210.

Accordingly, in describing the lighting module for a LiDAR apparatus according to the present embodiment, only the detailed configuration of the optical elements 210 that is different from the lighting module for a LiDAR apparatus according to the first embodiment of the present disclosure will be described.

For the rest of the configuration of the present disclosure, the same description of the lighting module for a LiDAR apparatus according to the first embodiment of the present disclosure may be applied.

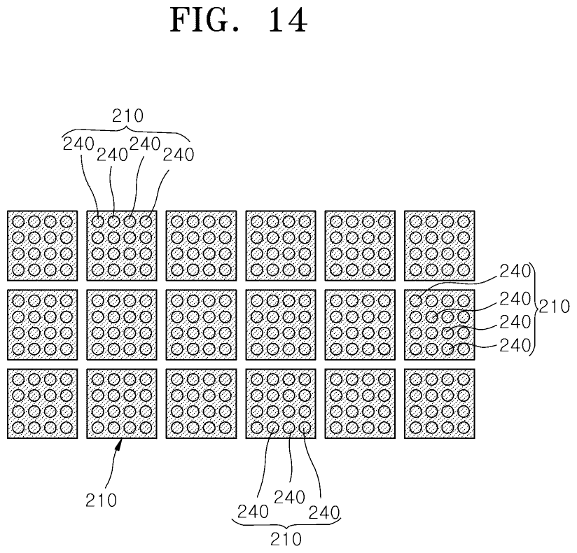

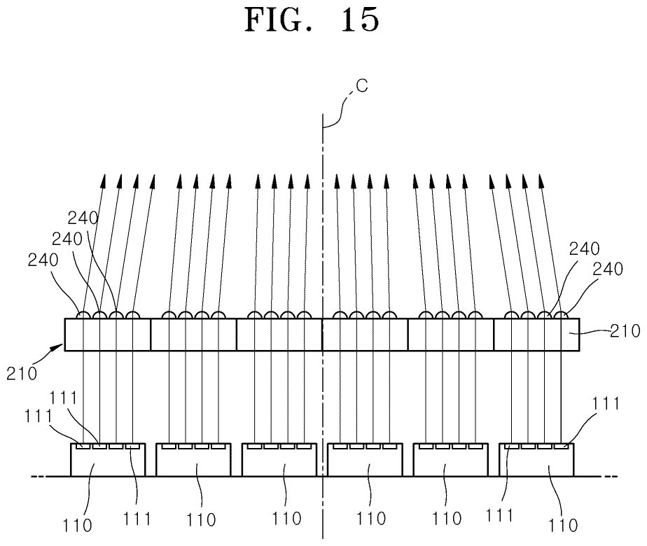

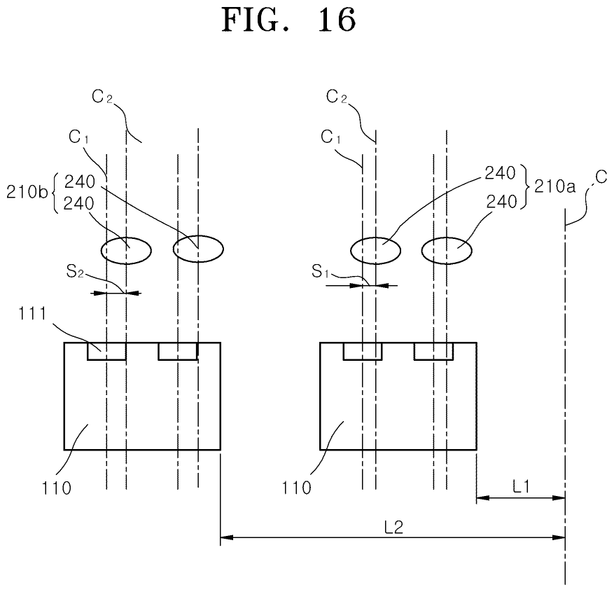

FIG. 14 is a plan view schematically showing a configuration of a shifting unit according to the fifth embodiment of the present disclosure. FIG. 15 is a side view schematically showing a configuration of the shifting unit according to the fifth embodiment of the present disclosure. FIG. 16 is an enlarged view schematically showing a configuration of any one pair of optical elements among a plurality of optical elements according to the fifth embodiment of the present disclosure.

Referring to FIGS. 14 to 16, the optical elements 210 according to the present embodiment may include a micro lens 240.

The micro lens 240 may be disposed to face the light-emitting element 111 along the direction parallel to the first axis C.

The micro lens 240 according to the present embodiment may have a shape of a convex lens with a convex surface. The micro lens 240 may be formed in a number corresponding to the light-emitting element 111. When a plurality of the light-emitting elements 111 are formed, each of the micro lenses 240 may be disposed to individually face a different light-emitting element 111.

The central axis C1 of the light-emitting element 111 and a central axis C2 of the micro lens 240 may be disposed to be misaligned with each other. That is, the central axis C1 of the light-emitting element 111 and the central axis C2 of the micro lens 240 may be spaced apart an offset distance from each other along a direction intersecting the first axis C, more specifically, along the direction perpendicular to the first axis C.

A distance from the central axis C2 of the micro lens 240 to the first axis C may be smaller than a distance from the central axis C1 of the light-emitting element 111 facing the micro lens 240 to the first axis C. Accordingly, light incident from the light-emitting element 111 onto the micro lens 240 may be refracted in the direction toward the first axis C.

The micro lenses 240 of the plurality of optical elements 210 may be disposed symmetrically with respect to the first axis C. Accordingly, light emitted from each of the light-emitting elements 111 may pass through the micro lens 240 and converge toward the first axis C.

Each of the optical elements 210 may refract light, emitted from different light-emitting sections 110, at different angles.

Referring to FIG. 16, a offset distance S2 of the second optical element 210b according to the present embodiment may be greater than a offset distance S1 of the first optical element 210a. Here, the offset distance S2 of the second optical element 210b may mean the offset distance S2 between the central axis C2 of the micro lens 240 and the central axis C1 of the light-emitting element 111 disposed to face each other in the second optical element 210b. In addition, the offset distance S1 of the first optical element 210a may mean the offset distance S1 between the central axis C2 of the micro lens 240 and the central axis C1 of the light-emitting element 111 disposed to face each other in the first optical element 210a.

Accordingly, the shifting unit 200 according to the present embodiment may further enhance lighting uniformity by forming a refraction angle of light emitted from the light-emitting sections 110 positioned relatively far from the first axis C to be greater than a refraction angle of light emitted from the light-emitting sections 110 positioned relatively close to the first axis C.

The offset distance S2 of the second optical element 210b and the offset distance S1 of the first optical element 210a may have different values within a range of 124 nm to 24.25 μm.

Although the present disclosure has been described with reference to the embodiments illustrated in the drawings, the embodiments are for illustrative purposes only, and those skilled in the art will appreciate that various modifications and other equivalent embodiments are possible from the embodiments. Therefore, the true technical scope of the present disclosure should be defined by the following claims.

What is claimed is:

1. A lighting module for a LiDAR apparatus, the lighting module comprising:
a VCSEL array provided with a plurality of light-emitting sections configured to emit light in a direction parallel to a first axis;
a light shifter disposed to face the VCSEL array, and configured to reduce a gap between the light emitted from adjacent ones of the light-emitting sections; and
a collimator disposed to face the light shifter.

2. The lighting module of claim 1, wherein the light shifter comprises a plurality of optical elements disposed to face each of the light-emitting sections.

3. The lighting module of claim 2, wherein each of the optical elements comprises:
a first surface disposed to face the light-emitting sections; and
a second surface disposed to face the collimator and disposed to form an inclination angle with respect to the first surface.

4. The lighting module of claim 3, wherein the optical elements comprise:
a first optical element spaced apart by a first set distance from the first axis; and
a second optical element spaced apart by a second set distance, the second set distance being greater than the first set distance, from the first axis,
wherein the inclination angle of the second surface of the second optical element is greater than the inclination angle of the second surface of the first optical element.

5. The lighting module of claim 2, wherein the optical elements are diffractive optical elements configured to diffract the light emitted from the light-emitting sections.

6. The lighting module of claim 5, wherein each of the optical elements comprises a plurality of grating patterns arranged at set spacing along a direction intersecting the first axis.

7. The lighting module of claim 6, wherein the optical elements comprise:
a first optical element spaced apart a first set distance from the first axis; and
a second optical element spaced apart a second set distance, the second set distance being greater than the first set distance, from the first axis,
wherein set spacing of the second optical element is smaller than set spacing of the first optical element.

8. The lighting module of claim 2, wherein the optical elements are a birefringent material configured to cause birefringence in the light emitted from the light-emitting sections.

9. The lighting module of claim 8, wherein each of the optical elements comprises:
a first surface disposed to face the light-emitting sections; and
a second surface disposed to face the collimator and disposed parallel to the first surface.

10. The lighting module of claim 8, wherein optical axes of the plurality of optical elements are disposed symmetrically with respect to the first axis.

11. The lighting module of claim 10, wherein the optical elements comprise:
a first optical element spaced apart a first set distance from the first axis; and
a second optical element spaced apart a second set distance, greater than the first set distance, from the first axis,
wherein a thickness of the second optical element is greater than a thickness of the first optical element.

12. The lighting module of claim 8, further comprising:
a wave plate disposed between the optical elements and the light emitting sections.

13. The lighting module of claim 12, wherein the wave plate is a quarter wave plate.

14. The lighting module of claim 2, wherein each of the light-emitting sections comprises at least one light-emitting element, and
wherein each of the optical elements comprises at least one micro lens disposed to face the light-emitting element.

15. The lighting module of claim 14, wherein a central axis of the light-emitting element and a central axis of the micro lens are spaced apart by an offset distance from each other along a direction intersecting the first axis.

16. The lighting module of claim 15, wherein the optical elements comprises:
a first optical element spaced apart a first set distance from the first axis; and
a second optical element spaced apart a second set distance, greater than the first set distance, from the first axis,
wherein an offset distance of the second optical element is greater than an offset distance of the first optical element.

17. A LiDAR apparatus for a vehicle, the LiDAR apparatus comprising:
a lighting module disposed on the LiDAR apparatus and including:
a VCSEL array including a plurality of light-emitting sections that emit light in a direction parallel to a first axis;
a light shifter comprises a plurality of optical elements disposed to face each of the light-emitting sections; and
a collimator disposed to face the light shifter,
wherein the light shifter converges paths of light emitted from the plurality of light-emitting sections toward the first axis, and reduces a gap between the light emitted from adjacent ones of the light-emitting sections.

18. The LiDAR apparatus of claim 17, wherein the light shifter prevents occurrence of an area of non-uniformity in the lighting output from the lighting module.

19. The LiDAR apparatus of claim 17, wherein each of the optical elements comprises:
a first surface disposed to face the light-emitting sections; and
a second surface disposed to face the collimator and disposed to form an inclination angle with respect to the first surface.

20. The LiDAR apparatus of claim 17, wherein the optical elements comprise refractive optical elements having one or more unique refractive indexes that refract light incident from the light-emitting sections.
